(19) United States
(12) Patent Application Publication
(10) Pub. No.: US 2012/0161746 A1
(43) Pub. Date: Jun. 28, 2012

(54) LOW-POWER OPERATION FOR DEVICES WITH CIRCUITRY FOR PROVIDING REFERENCE OR REGULATED VOLTAGES

(75) Inventors: Eivind Holsen, Trondheim (NO); Torgeir Fenheim, Mo i Rana (NO)

(73) Assignee: ATMEL Corporation, San Jose, CA (US)

(21) Appl. No.: 12/976,865

(22) Filed: Dec. 22, 2010

(51) Int. Cl. G05F 1/56

(52) U.S. Cl. 323/318

(57) ABSTRACT

A device includes a voltage regulator and/or circuitry for generating a reference voltage. The voltage regulator and the circuitry for generating the reference voltage are operable in a continuous mode or a sample mode. Operating in the sample mode can help reduce overall power consumption of the device. During the sample mode, the voltage regulator and/or the circuitry for generating the reference voltage periodically are enabled to restore energy to respective energy storage components (e.g., capacitors).

### BACKGROUND

Low-dropout (“LDO”) and other voltage regulators can be used to provide a suitable supply voltage for internal logic, input/output (“I/O”) lines and analog circuitry in a wide variety of electronic and other devices. For example, in one particular application, an on-chip LDO voltage regulator can be incorporated as part of an integrated chip battery management and protection system. The presence of the voltage regulator, however, can increase overall power consumption by the system. The increase in power consumption may be attributable, for example, to power loss in the regulator loop and the fact that the voltage regulator itself consumes power. Likewise, various devices require circuitry for providing a reference voltage. The presence of such circuitry also can increase overall power consumption.

### SUMMARY

The details of one or more implementations of the invention are set forth in the accompanying drawings and the description below.

In accordance with one aspect, an apparatus includes a device that a voltage regulator and/or circuitry for generating a reference voltage. The voltage regulator and the circuitry for generating the reference voltage are operable in a continuous mode or a sample mode. Operating in the sample mode can help reduce overall power consumption of the device. During the sample mode, the voltage regulator and/or the circuitry for generating the reference voltage periodically are enabled so that energy is restored to respective energy storage components (e.g., capacitors).

Other aspects, features and advantages of the invention will be apparent from the description and drawings, and from the claims.

### BRIEF DESCRIPTION OF THE DRAWINGS

FIG. 1 is a schematic diagram of a battery pack operating circuit.

FIG. 2 is a block diagram illustrating an example of modules in a battery management and protection system.

FIG. 3 illustrates circuitry for operating a voltage regulator or other modules in a sample mode.

### DETAILED DESCRIPTION

In the following description, reference is made to a one-chip battery management and protection system in which a microcontroller, non-volatile memory and other circuit components are integrated in single integrated circuit. However, the system also can be realized in a multi-chip solution. Although the particular implementation described below is for a lithium-ion battery cell management and protection system, the low-power sample mode described below can be used in connection with other devices and systems as well.

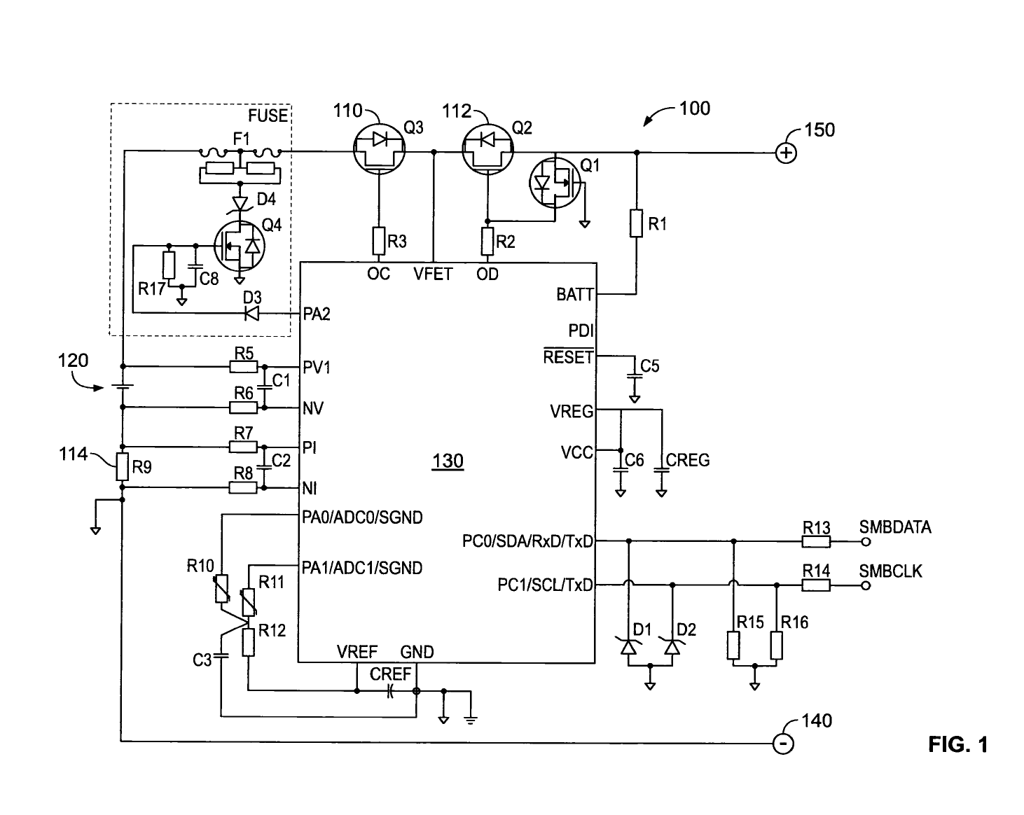

As shown in FIG. 1, battery pack 100 includes one or more battery cells 120, discrete transistors 110, 112, a sense resistor 114, and a battery management and protection system 130. System 130 includes various components, as discussed below, which can be integrated in a single package (e.g., integrated into a single integrated circuit) or packaged separately. Discrete transistors 110, 112 can be separate from system 130 and included in a separate package or can be packaged together with other system components.

Discrete transistors 110, 112 are used as switches to disconnect the battery cells 120 from the external battery pack terminals (i.e., external battery pack positive terminal 140 and negative terminal 150). In the illustrated implementation, two discrete transistors are shown, which can be implemented, for example, as field effect transistors (FETs). Although other transistor technologies can be used, FETs present advantages in terms of process, performance (e.g., on-resistance), cost and size. In the implementation shown, two transistors are provided and represent separate charge 110 and discharge 112 transistors. Charge transistor 110 is used to enable safe charging of the battery cells 120. Discharge transistor 112 is used to enable safe discharging of the battery cells 120.

The junction between the FET transistors 110, 112 is coupled to system 130 at an input (VFET), which provides operational power to system 130. An on-chip LDO voltage regulator regulates the voltage at terminal VFET to provide a suitable supply voltage (e.g., 2.2 V) for internal logic, I/O lines and analog circuitry. This regulated voltage also is provided to external pin VREG. For stable operation of system 130, a capacitor CREG is provided external to chip 130 and is coupled to pin VREG. Capacitor CREG also serves as a reservoir capacitor for energy storage to ensure that system 130 is able to operate for some time with very low voltage at terminal VFET.

Although capacitor CREG is shown as being external to chip 130 in the illustrated example, in some implementations, capacitor CREG (or some other energy storage device) is inside a chip having multiple dies contained within a single package. In this case, capacitor CREG can be provided on a die different from the die containing chip 130.

Battery cell 120 is a rechargeable battery and can be of the form of lithium ion (Li-ion) or lithium polymer (Li-polymer). Other battery technology types are possible. Where multiple cells are provided, the battery cells are coupled in series, in parallel or a combination series and parallel cells. In the illustrated implementation, the positive terminal of battery cell 120 is coupled to system 130 (e.g., to allow for the detection of the battery voltage level at input PV1) and to one of the discrete transistors (i.e., the charge transistor 110). The negative terminal of the battery cell 120 also is coupled to system 130 (e.g., to allow for the detection of the battery voltage level at input NV), to one terminal of sense resistor 114,

Sense resistor 114 is coupled to system 130 (to allow for the measurement of current flow through sense resistor 114 at input PI). The second terminal of the sense resistor is coupled to local ground (smart battery local ground), the system 130 (to allow for the measurement of current flow through sense resistor 114 at input NI) and to the external battery pack negative terminal 140 of battery pack 100. Although a single battery cell implementation is shown, other numbers of battery cells can be included in battery pack 100.

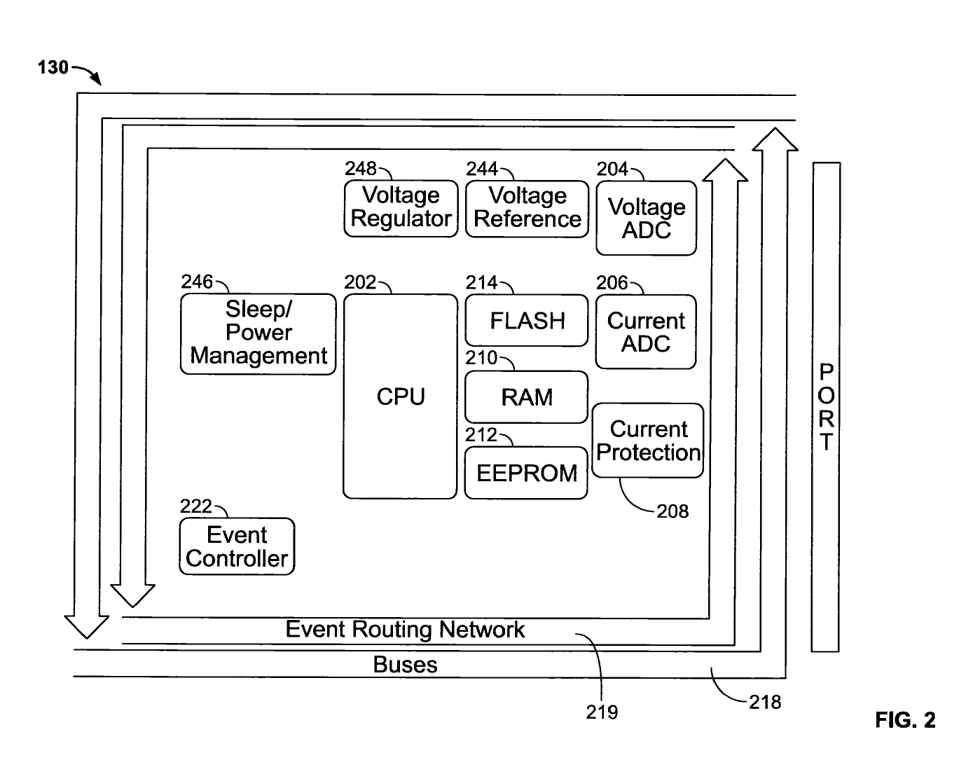

As illustrated in FIG. 2, battery management and protection system 130 includes a software-based central processing unit (CPU) 202, which can be implemented, for example, as a low-power, CMOS 8-bit microcontroller based on a RISC architecture. CPU 202 ensures correct program execution and is able to access memories, perform calculations and control other modules in the system. Memory (e.g., flash memory 214) stores instructions that can be executed by CPU 202. Other memory in system 130 includes random access memory (RAM) 210 and EEPROM 212.

CPU 202 and other modules send and receive signals over one or more buses 218 (FIG. 2). In addition, a dedicated routing network 219 allows “events” to be sent between certain modules independently of CPU 202.

In the illustrated example, the on-chip LDO regulator 302 that regulates the VFET terminal voltage to provide a suitable supply voltage for internal logic, I/O lines and analog circuitry, can be incorporated as part of voltage regulator module 248.

System 130 includes various modules that perform battery measurement and provide battery protection. Examples of these modules are voltage analog-to-digital converter (V-ADC) module 204 and current analog-to-digital converter (C-ADC) module 206. These modules, which include circuits and logic, are discussed in greater detail below.

V-ADC module 204 can be implemented, for example, as a 16-bit sigma-delta analog-to-digital converter that is optimized for measuring voltage and temperature. It includes several selectable input channels such as scaled battery cell voltage, general purpose inputs (e.g., for use as an external temperature sensor), an internal temperature sensor, scaled battery voltage (BATT), and diagnosis functions. V-ADC 204 can execute single conversions or channel scans of battery voltage and temperature.

C-ADC module 206 is arranged to measure current flowing through an external sense resistor (e.g., sense resistor 114 in FIG. 1). In the illustrated implementation, C-ADC module 206 provides both instantaneous and accumulated outputs. The instantaneous current value can be useful for various critical tasks in battery management such as supervising charging current during under-voltage recovery and fast charge, monitoring state of the battery pack (e.g., standby or discharge), providing accurate over-current protection, and performing impedance calculations.

The illustrated system 130 includes a voltage reference module 244 that provides a highly accurate reference voltage (e.g., 1.100 V), as well as an internal temperature reference, to V-ADC module 204. For example, in the illustrate implementation, module 244 provides a reference voltage of 1.100 V to V-ADC 204. This reference voltage also is provided to pin VREF (FIG. 1). A capacitor CREF is provided external to chip 130 and is coupled to pin VREF.

Event controller 222 includes timekeeper 308, which serves as a centralized timer that controls when certain events occur and is coupled by dedicated routing network 219 directly to some of the modules. Timekeeper 308 generates a set of divided clock signals. For example, in the illustrated implementation, timekeeper 240 includes a prescaler that uses a clock pulse signal (clk) and generates power-of-2 clock divisions from the clock signal (e.g., clock signals each of which has a respective frequency clk/2 . . . clk/2ⁿ, where n is an integer). Timekeeper events to all modules can be synchronous.

Sleep/power management control module 246 allows system 130 to enter one or more sleep (i.e., low-power) modes to reduce power consumption. The sleep modes can be entered from an active mode in which CPU 202 is executing application code. The application code decides when to enter a sleep mode and what sleep mode to enter. Interrupt signals from enabled modules and enabled reset sources can restore CPU 202 from a sleep mode to active mode.

A first sleep mode available in some implementations is referred to as an idle mode, in which operations of CPU 202 and non-volatile memory are stopped. In the idle mode, operations of certain other modules continue operating while they are enabled. Interrupt requests from enabled interrupt signals wake system 130. To reduce power consumption in the idle mode, modules that are not in use can be actively disabled. A second sleep mode is referred to as a power-save mode, in which asynchronous modules and the event system continue to operate. A third sleep mode is referred to as power-down mode, in which voltage reference module 244, as well as the LDO regulator 302, enter an ultra-low power mode to reduce power consumption.

A practical implementation of system 130 can include other components, modules and subsystems, which have been removed from FIG. 2 for clarity purposes. Furthermore, some implementations may not include all the illustrated components, modules and subsystems.

The presence of the integrated LDO voltage regulator 302 can cause system 130 to consume more power than it otherwise would in the absence of the LDO voltage regulator because, in addition to power loss in the regulator loop, the LDO voltage regulator itself consumes power. Several modes of operation can help reduce overall power consumption. For example, when system accuracy is low and, for example, the current consumption requirement is low, the LDO voltage regulator 302 can be disabled to allow system 130 to operate only on the charge stored on external capacitor CREG.

To reduce overall power consumption of the system even further, system 130 is configured to enable LDO voltage regulator 302 to operate in a sample mode. The sample mode, which can allow very low power consumption with FETs 110, 112 and a current protection module 208 enabled, preferably is permitted only when system 130 is in a low power operation mode. Thus, in some implementations, idle power waste in system 130 can be significantly reduced or eliminated without having to disable the entire system. Further details of the continuous mode and sample mode of operation are discussed below.

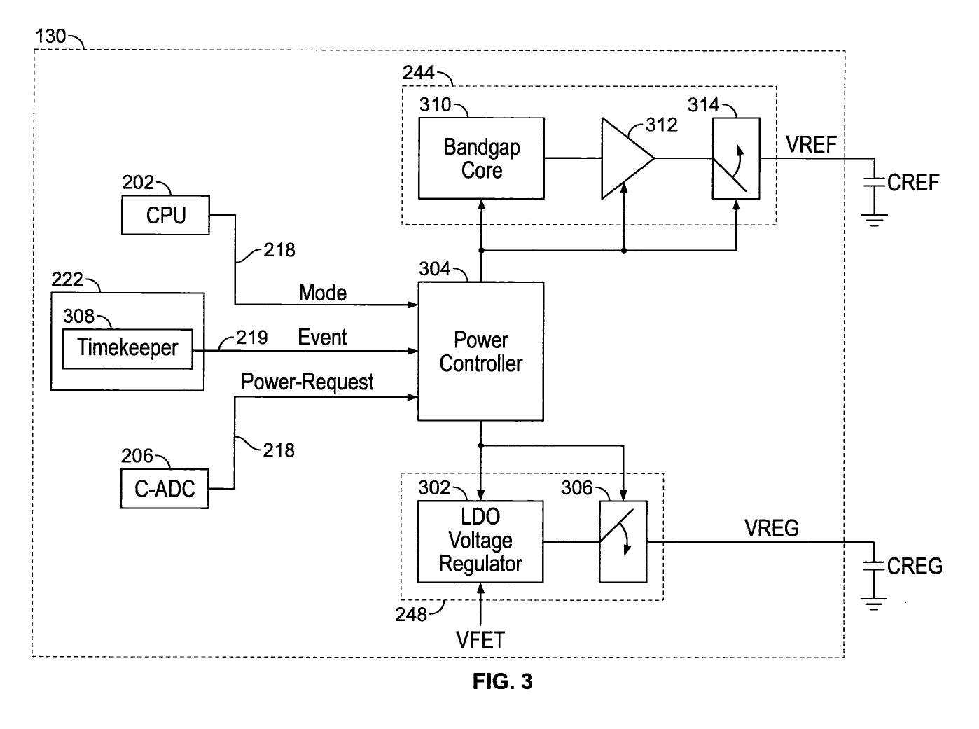

As shown in FIG. 3, LDO voltage regulator 302 is coupled to a power controller 304, which can be implemented, for example, as a digital module that includes circuitry and logic. Power controller 304 provides control signals to LDO voltage regulator 302 as well as to a switch 306. Power controller 304 controls LDO voltage regulator 302 to operate in the continuous or sample mode of operation in accordance with the control signal. Switch 306 can be implemented, for example, as a high-current transistor, and opens or closes in accordance with the control signal from power controller 304. An output of LDO voltage regulator 302 is coupled to an input of switch 306, and an output of switch 306 is coupled to the VREG pin, which in turn is coupled to capacitor CREG.

In the illustrated implementation, power controller 304 receives several input signals, including a MODE signal from CPU 202, an EVENT signal, for example, from timekeeper 308, and a POWER-REQUEST signal, for example, from C-ADC 206. The MODE signal indicates the mode of operation. The EVENT signal triggers events as described below when LDO voltage regulator 302 is operating in the sample mode. The POWER-REQUEST signal allows certain modules such as C-ADC 206 to cause LDO voltage regulator 302 to operate in continuous mode regardless of the MODE signal from CPU 202. Thus, the POWER-REQUEST signal effectively can override the MODE signal.

In the continuous mode, the LDO voltage regulator 302 is continuously on and switch 306 is closed. When LDO voltage regulator 302 is turned on, it can deliver high current, which may be required, for example, when system 130 is operating in active operation modes. When operated in the continuous mode, capacitor CREG is charged.

In the sample mode, switch 306 is turned off for periods of time. Charge stored by external capacitor CREG allows system 130 to continue to operate, so long as system 130 does not draw too much current such that external capacitor CREG is drained. Accordingly, as noted above, the sample mode of operation preferably is permitted only when system 130 is in a low power operation mode. While switch 306 is disabled (i.e., open), LDO voltage regulator 302 can be powered down to reduce power consumption. To allow charge stored by capacitor CREG to be provided to system 130, capacitor CREG can be connected directly to the modules supply lines. The LDO voltage regulator 302 can be connected to capacitor CREG via internal switch 306.

When LDO voltage regulator 302 is operating in the sample mode, power controller 304 ensures that capacitor CREG is refreshed periodically (e.g., every 32 milliseconds ms)) by closing switch 306. Timing of a refresh action is triggered by the EVENT signal, which causes power controller 304 to enable LDO voltage regulator 302 and to close switch 306, thereby recharging capacitor CREG. In the illustrated implementation, the EVENT signal is generated by timekeeper 308, which operates independently of CPU 202 and sends event signals over dedicated routing network 119. In other implementations, the EVENT signal can be generated by some other module or logic in system 130.

In some implementations, timing of the sample mode is dependent on the leakage current from the capacitor VREG storing the voltage during the off period. In some implementations, the refresh interval (e.g., 32 ms) is a programmable parameter that can be set, for example, during manufacture of system 130. When a refresh event occurs, LDO voltage regulator 302 is enabled for a short period of time before it is switched off again. The sample mode can, therefore, help reduce power consumption in system 130.

In addition to enabling LDO voltage regulator 302 and closing switch 306 periodically in response to an EVENT signal from timekeeper 308, power controller 304 can enable LDO voltage regulator 302 and close switch 306 in other situations as well. In particular, when LDO voltage regulator 302 is operating in the sample mode and a module (e.g., C-ADC 206) requiring higher power current is enabled, the module sends a POWER-REQUEST signal to power controller 304. The POWER-REQUEST signal causes power controller 304 to enable LDO voltage regulator 302 and close switch 306 to ensure that LDO voltage regulator 302 has high driving capability. In some implementations, before entering a low-power mode (e.g., power-down mode), CPU 202 configures C-ADC module 206 for operation in the sample mode so that C-ADC module 206 will send the POWER-REQUEST signal if it is enabled while LDO voltage regulator 302 is operating in the sample mode.

In the illustrated implementation of FIG. 3, power controller 304 also is coupled to voltage reference module 244, which, as explained above, generates a temperature stable reference voltage VREF for V-ADC module 204. Voltage reference module 244 includes a bandgap core 310, and a buffer 312 to drive external capacitor CREF. A switch 314, which can be implemented as a transistor, can be opened and closed to sample the buffered reference voltage. In other implementations, switch 314 need not be separately provided from buffer 312. Instead, the output of buffer 312 can be placed in tri-state when buffer 312 is switched off.

Voltage reference module 244 also can be operated in either the continuous mode or the sample mode. In particular, power controller 304 controls the mode of operation of voltage reference module 244 based on the three input signals discussed above (i.e., MODE, EVENT, POWER-REQUEST).

In the continuous mode, switch 314 remains closed, and bandgap core 310 and buffer 312 remain powered on. The accuracy of the voltage reference in this mode is very high, but the current consumption also is relatively high. Bandgap core 310 can be operated in the continuous mode, for example, when the reference voltage is used as input to high accuracy modules such as ADCs (e.g., V-ADC module 204 and C-ADC module 206) and digital-to-analog converters.

In the sample mode, switch 314 is turned off for periods of time. Charge stored by external capacitor CREF allows the reference voltage system to continue to be provided to various system components. To allow charge stored by capacitor CREF to be provided to system 130, CREF can be connected directly to all the modules requiring reference voltage to operate. Bandgap voltage reference 244 can be connected to capacitor CREF via internal switch 314. While switch 314 is disabled (i.e., open), bandgap core 310 and buffer 312 can be powered down to reduce power consumption. High impedance loads (e.g., comparators) can be permitted to operate while bandgap core 310 and buffer 312 are powered down and switch 314 is disabled, as no current is drawn from the high impedance load. Current protection module 208 (FIG. 2) is an example of such a module.

When reference voltage module 244 is operating in the sample mode, power controller 304 also ensures that capacitor CREF is refreshed periodically (e.g., every 32 ms) by closing switch 314. Timing of a refresh action is triggered by the EVENT signal, which causes power controller 304 to enable bandgap core 310 and buffer 312 and to close switch 314, thereby recharging capacitor CREF. In the illustrated implementation, the sample mode is enabled automatically in power-down sleep mode, whereas in other operating modes, the continuous mode is used. In other implementations, the sample mode may be used at other times as well. In some implementations, timing of the sample mode is dependent on the leakage current from the capacitor CREF storing the voltage during the off period.

In addition to enabling bandgap core 310 and buffer 312 and closing switch 314 periodically in response to an EVENT signal from timekeeper 308, power controller 304 enables bandgap core 310 and buffer 312 and closes switch 314 in another situation as well. In particular, if a POWER-REQUEST signal is provided to power controller 304, then power controller 304 enables bandgap core 310 and buffer 312 and closes switch 314 so as to provide a high accuracy reference voltage. The sample mode of operation can, therefore, help reduce overall power consumption in system 130, but also can enable the system to provide a high accuracy reference voltage and sufficient current and power to modules requiring higher current and power for proper operation.

Although the particular example discussed above includes a LDO voltage regulator, the sample mode can be used with other types of voltage regulators as well.

Other implementations are within the scope of the claims.

What is claimed is:

1. An apparatus comprising:
a device comprising a voltage regulator;
an energy storage component connected to the device;
a switch coupled between an output of the voltage regulator and the energy storage component, wherein the switch is operable to be opened and closed; and
a controller arranged to provide control signals to the voltage regulator and the switch, wherein the voltage regulator is operable in a first mode in which, at specified times, the voltage regulator is turned off and the switch is opened, wherein, while the switch is open, the energy storage component provides energy to the device, and wherein in the first mode the controller periodically causes the switch to close and enables the voltage regulator to perform voltage regulation operations to restore energy to the energy storage component.

2. The apparatus of claim 1 wherein the device has at least one low power mode of operation and wherein the first mode for the voltage regulator is permitted only when the device is in a low power operation mode.

3. The apparatus of claim 1 wherein the voltage regulator is operable in a second mode in which voltage regulation operations of the voltage regulator are enabled continuously and during which the switch remains closed.

4. The apparatus of claim 1 wherein the device includes a central processing unit and a timekeeper to provide an event signal to the controller independently of the central processing unit, wherein the event signal triggers the controller to enable the voltage regulator to perform voltage regulation operations and triggers the controller to close the switch.

5. The apparatus of claim 4 wherein the central processing unit is arranged to provide a signal to the controller, wherein the signal from the central processing unit specifies a mode for the voltage regulator.

6. The apparatus of claim 1 wherein the controller is operable to receive a signal from a module requiring high power current, wherein in response to receiving the signal the controller enables the voltage regulator to perform voltage regulation operations and causes the switch to close.

7. The apparatus of claim 6 wherein the device is an integrated chip.

8. The apparatus of claim 1 wherein the device is an integrated chip battery management and protection system that includes the voltage regulator, the switch and the controller, and wherein the energy storage component is a capacitor external to the integrated chip.

9. A method of operating a device comprising a voltage regulator, the method comprising:
operating the voltage regulator in a first mode, wherein operating in the first mode includes:
at specified times, turning off the voltage regulator and opening a switch coupled between an output of the voltage regulator and an energy storage component coupled to the device, wherein, while the switch is open, the energy storage component provides energy to the device; and
periodically causing the switch to close and enabling the voltage regulator to perform voltage regulation operations to restore energy to the energy storage component.

10. The method of claim 9 including operating the voltage regulator in the first mode only when the device is in a low power operation mode.

11. The method of claim 9 including operating the voltage regulator in a second mode, wherein operating in the second mode includes:
enabling the voltage regulator to perform voltage regulation operations continuously and causing the switch to remain closed.

12. The method of claim 9 including providing an event signal independently of a central processing unit in the device, wherein the event signal triggers a controller to enable the voltage regulator to perform voltage regulation operations and triggers the controller to close the switch.

13. The method of claim 9 including:
receiving a signal from a module requiring high power current; and
in response to receiving the signal from the module, enabling the voltage regulator to perform voltage regulation operations and causing the switch to close.

14. The method of claim 9 wherein the device is an integrated chip battery management and protection system that includes the voltage regulator and the switch and the controller, and wherein the energy storage component is a capacitor external to the integrated chip.

15. An integrated circuit chip comprising:
a device comprising a voltage regulator;
an input/output pin for connection to an external capacitor, wherein the input/output pin is coupled to other components of the device;
a switch for coupling an output of the voltage regulator to the input/output pin, wherein the switch is operable to be opened and closed; and
a controller arranged to provide control signals to the voltage regulator and the switch, wherein the voltage regulator is operable in a first mode in which, at specified times, the voltage regulator is turned off and the switch is opened, and wherein in the first mode the controller periodically causes the switch to close and enables the voltage regulator to perform voltage regulation operations.

16. The integrated circuit of claim 15 wherein the device has at least one low power mode of operation and wherein the first mode for the voltage regulator is permitted only when the device is in a low power operation mode.

17. The integrated circuit of claim 15 wherein the voltage regulator is operable in a second mode in which voltage regulation operations of the voltage regulator are enabled continuously and during which the switch remains closed.

18. The integrated circuit of claim 15 comprising a battery management and protection system.

19. An apparatus comprising:
a device comprising circuitry to generate a reference voltage;
an energy storage component;
a buffer coupled between an output of the circuitry and the energy storage component; and
a controller arranged to provide control signals to the circuitry and the buffer, wherein the circuitry is operable in a first mode in which, at specified times, the circuitry and the buffer are turned off, wherein, while the buffer is not driving the energy storage component, the energy storage component provides energy to the device, and wherein in the first mode, the controller periodically enables the circuitry to generate the reference voltage and causes the buffer to drive the energy storage component so that energy is restored to the energy storage component.

20. The apparatus of claim 19 wherein the circuitry is operable in a second mode in which the circuitry is enabled to generate the reference voltage continuously and during which the buffer drives the energy storage component.

21. The apparatus of claim 19 wherein the device includes a central processing unit and a timekeeper to provide an event signal to the controller independently of the central processing unit, wherein the event signal triggers the controller to enable the circuitry to generate the reference voltage and triggers the controller to cause the buffer to drive the energy storage component.

22. The apparatus of claim 21 wherein the central processing unit is arranged to provide a signal to the controller, wherein the signal from the central processing unit specifies a mode for the voltage regulator.

23. The apparatus of claim 19 wherein the controller is operable to receive a signal from a module requiring high power current, wherein in response to receiving the signal the controller enables the circuitry to generate the reference voltage and causes the buffer to drive the capacitor.

24. The apparatus of claim 19 wherein the device is an integrated chip battery management and protection system that includes the circuitry to generate the reference voltage, the buffer and the controller, and wherein the energy storage component is a capacitor external to the integrated chip.

25. A method of operating a device comprising circuitry for generating a reference voltage, the method comprising:
operating the circuitry in a first mode, wherein operating in the first mode includes:
at specified times, turning off the circuitry and a buffer that is coupled between an output of the circuitry and an energy storage component, wherein, while the buffer is not driving the energy storage component, the energy storage component provides energy to the device; and
periodically enabling the circuitry to generate the reference voltage and causing the buffer to drive the energy storage component so that energy is restored to the energy storage component.

26. The method of claim 26 including operating the circuitry in a second mode, wherein operating in the second mode includes:
enabling the circuitry to generate the reference voltage continuously and causing the buffer to drive the energy storage component.

27. The method of claim 26 including providing an event signal independently of a central processing unit in the device, wherein the event signal triggers a controller to enable the circuitry to generate the reference voltage and triggers the controller to cause the buffer to drive the energy storage component.

28. The method of claim 26 including:
receiving a signal from a module requiring high power current; and
in response to receiving the signal from the module, enabling the circuitry to generate the reference voltage and causing the buffer to drive the energy storage component.
